(19) United States
(12) Patent Application Publication
(10) Pub. No.: US 2023/0341335 A1
(43) Pub. Date: Oct. 26, 2023

(54) APPARATUS AND METHOD FOR INSPECTING CLOSED CONTAINERS

(71) Applicant: KRONES AG, Neutraubling (DE)

(72) Inventors: Anton NIEDERMEIER, Offenstetten (DE); Rainer KWIRANDT, Barbing (DE); Stefan PIANA, Koefering (DE)

(21) Appl. No.: 18/021,093

(22) PCT Filed: Jul. 21, 2021
(86) PCT No.: PCT/EP2021/070459

§ 371 Date: Feb. 13, 2023

(30) Foreign Application Priority Data
Aug. 11, 2020 (DE) 10 2020 121 088.4

(51) Int. Cl. G01N 21/90; B67C 3/22

(52) U.S. Cl. CPC G01N 21/90; B67C 3/22

(57) ABSTRACT

An inspection device for inspecting containers with the container closures arranged thereon, has a lighting device which illuminates the containers to be inspected and an image recording device which is configured for recording spatially resolved images of the containers. The
image recording device is at least also aligned with regions of the containers which are arranged in a longitudinal direction of the container below the container closures arranged on the containers, and an evaluation device is provided which is configured to, from at least one image recorded of the container provided with the marking, a relative rotational position of this container with respect to the container closure arranged on the container.

The present invention relates to an apparatus and a method for inspecting closed containers. In the prior art, it is known that containers are filled with a liquid and then closed with closures. These closures are usually screwed onto the respective container.

After filling beverages into bottles made of glass or plastic, the closure is usually applied directly after the filling process. In the case of screw caps, usually made of plastic, the container should be closed gas- and liquid-tight.

If the container closure does not seal properly, this can have considerable negative consequences. For example, it can lead to contamination by germs penetrating from the outside and thus to health risks for the consumer. In addition, there can also be a loss of pressure from carbon dioxide and thus an impairment of the taste experience.

In addition, there may also be a loss of pressure from nitrogen previously dripped in liquid form and, due to the lack of stability of the plastic container, stackability on a pallet may also be impaired.

In addition, the taste can also be impaired due to product degradation caused by entered oxygen. These effects can ultimately also lead to a reputational or compensation risk for the producer.

Therefore, checking the closure for correct fit and thus implicitly checking the tightness of the sealing system is an essential quality assurance measure. In the event of leaks between the screw cap and the container, various methods and apparatus are known.

It is known, for example, that a closure fit inspection is carried out by means of a camera from the side in a transmitted light process. The distance between the top or bottom of the closure or the retaining ring and the mouth of the container is measured, e.g. using a support ring for PET bottles. To increase the measuring accuracy, two views offset by 90° or 3 views offset by 60° or 120° are usually used, as well as imaging through a telecentric lens.

In addition, a cap curvature check by means of an inductive or optical distance grid from above is known for carbonised or cooled products. The cap curvature is used to determine the internal pressure and thus indirectly also the tightness.

In addition, a closure angle of rotation detection by means of a camera from above, in particular with evaluation of the alignment angle between the container and the closure, is also known. This detection uses image processing to search for the position of an angle-determining feature on the closure and also a feature on the container, which is usually transported in any rotational position. Typically, this feature is located on a support ring and thus monitors the decisive parameter of the untwist angle for the tightness of a closure.

In addition, a closure—angle of rotation detection by means of a camera in horizontal direction and using a reflected light illumination is also known. This detection uses image processing or optical sensor technology to search for the position of an angle-determining feature on the closure and a feature on the outside of a container that is usually transported in any rotational position, and thus monitors the decisive parameter of the distance between the two markings for the tightness of a closure.

Especially with still water bottles made of plastics such as PET, very flat and thin-walled screw caps are arranged, in order to keep the use of materials as low as possible. With such closures, the accuracy of measuring the closure fit from the side or a bulge check is no longer sufficient to guarantee tightness. In these cases, a check of the twist-on angle, i.e. the alignment angle of the closure relative to the container with a narrow angular tolerance of a few degrees, is necessary.

Also for reasons of resources and cost, the support ring at the lower end of the mouthpiece of a typical plastic still water bottle is increasingly kept very small so that it can hardly or no longer be seen from above under the cap. It is also known to save the support ring completely. Therefore, cap rotation angle detection, in which the angular position of features on the cap and the support ring are viewed and evaluated from above, can no longer be applied here.

The present invention is therefore based on the object of providing a container closure control for containers which, on the one hand, works very precisely and, on the other hand, can also be used for containers which do not have support rings or largely do without them.

These objects are achieved according to the invention by the subject matters of the independent patent claims. Advantageous embodiments and further developments are the subject of the subclaims.

An apparatus according to the invention for treating containers has a transport device which transports the containers along a predetermined transport path, and a filling device which fills the containers with a flowable and, in particular, liquid medium, and a closing device which attaches closures to the filled containers and, in particular, screws these closures onto the containers. Furthermore, an inspection device is provided which is arranged downstream of the closing device in the transport direction of the containers and which inspects the containers with the container closures arranged thereon, wherein the inspection device having an illumination device which illuminates the container to be inspected and an image recording device which is suitable and intended for recording spatially resolved images of the containers.

According to the invention, the image recording device is at least also aligned with regions of the containers which are arranged in a longitudinal direction of the container below the container closures arranged on the containers, and a viewing direction of the image recording device includes an angle of more than 20° with the longitudinal direction of the containers in such a way that at least one marking attached to the container can be detected by the image recording device. Thus, this angle denotes the angle of the camera axis to the bottle axis or container axis.

Furthermore, an evaluation device is provided which determines a relative rotational position of this container with respect to the container closure arranged on the container from an image taken of the container provided with the marking. In particular, a rotational position with respect to the longitudinal direction of the container is determined. From the rotational position, it can in turn be determined whether the closure is properly arranged on the container.

The rotational position of the closure in relation to the container is directly linked to the height position of the closure above the container mouth via the thread pitch in screw closures. If the ideal height position deviates beyond a specified level, the closure tightness cannot be guaranteed and the container must be regarded as defectively closed.

It is thus proposed that a rotational position of the container closure is determined, in order to conclude the closure state. Preferably, the container closure also has a marking which is indicative of the rotational position of the closure with respect to the longitudinal direction of the container. Particularly preferably, the above-mentioned angle of the image recording device with respect to the longitudinal direction is greater than 30°, preferably greater than 40°, preferably greater than 50°, preferably greater than 60° and particularly preferably greater than 70° and preferably of more than 73° (with respect to the longitudinal direction). A horizontal or approximately horizontal angle (i.e. 90° with respect to the longitudinal direction) of the camera is advantageous for inspection.

Preferably, an opening angle of the image recording device or of a lens is selected in such a way that the closure is fully captured. Depending on the lens and the camera distance, the optimal angle of view can be chosen differently. For example, if the imaging recording device or camera is 200 mm away, then a 28 mm shutter takes up an angle of view of 8°.

As mentioned above, the closures are in particular closures screwed or screwed on to the container or the mouth. In particular, the closures are screwed onto an external thread of the container.

Particularly preferably, the containers are transparent or translucent. Preferably, the containers are plastic or glass containers.

In a preferred embodiment, the lighting device is designed with a large surface area. The lighting device can emit both diffuse and directional radiation. In addition, the lighting device can be arranged telecentrically. In addition, it is also possible that the lighting device emits radiation that is two-dimensional with contrasting structures. In this case, the container can be imaged opposite a high-contrast surface.

Particularly preferably, the container or the area to be inspected is located between the lighting device and the image recording device. This means that the inspection is particularly preferably carried out using the transmitted light method. Particularly preferably, the image recording device is directed at an unfilled area of the container, i.e. in particular at an area in which no liquid is yet arranged inside the container. The markings of the container are also advantageously arranged in a neck area of the container, as for example below a support ring but above the normal liquid level, preferably directly below the support ring or closure in the case of containers without a support ring, since this area is stretched the least during the stretch blow-moulding process.

This is usually the neck area of the container, which is directly below the mouth. This area is particularly suitable for observing the markings on the container, as the image recording is not disturbed by the liquid inside the container or there is no medium or filling product in front of or behind the markings. This means that the markings can be detected more reliably and in a much larger angular range around the container axis than at the level of the product due to its light refraction properties.

This is especially true for liquids that are not very transparent. It is therefore proposed that an angle-determining feature on the container is not detected from above but from the side and in particular in transmitted light.

In this case, the said features or markings on the container can, for example, consist of single or multiple clear structures next to each other and, in particular, vertical structures, i.e. structures running in the longitudinal direction of the container, which can be reliably detected even under unfavourable conditions. In order to be able to reliably detect the features preferably at any angular position, several views are required in a preferred embodiment so that the features can be reliably detected in at least one view.

The observation is, as mentioned above, a view from the side, wherein a view from the side is understood here to be a viewing direction of a camera essentially from a horizontal direction (with the longitudinal direction of the container essentially vertical) with a predetermined elevation angle.

A transmitted light or transmitted light observation is understood to mean that the containers are transparent or translucent and that there is appropriate illumination on the opposite side of the observation area to the camera.

Since in transmitted light—especially at horizontal viewing angles—in addition to the structures on the front wall, any interfering structures on the rear wall may also be visible, measures can also be taken, such as observing the container from an oblique direction that is slightly offset from the horizontal (so that the rear wall is shown in the camera image at a different height position).

In a preferred embodiment, at least one marking attached to the container closure can be detected by the recording device. From the detection of this marking on the closure and also the marking on the container, a relative rotational position between the closure and the container can be concluded.

Preferably, therefore, the evaluation device determines the relative rotational position of this container with respect to the container closure arranged on the container and, in particular, screwed on, from an image recorded by the closure provided with the marking. Preferably, the apparatus has a processor device which, on the basis of the determined rotational position, determines whether the closure is properly arranged on the container.

It is possible for the evaluation device to determine a rotational position of the closure in relation to the container and for a processor device to determine from this rotational position whether the closure is properly arranged on the container. For example, limit values can be defined for the rotational position. If the determined rotational position lies within these limit values, the container is considered to be properly closed; if the rotational position lies outside these limit values or at least above one of these limit values, the container is considered to be faulty.

In a further preferred embodiment, the detection may include an ambiguity check. Should a closure have a thread that is, for example, approximately or more than 180°, an ambiguity could arise, namely if the closure is screwed on too little by one or more whole turn(s). In this case, the rotational position of the closure relative to the container could be within the permitted angular tolerance, but still not seal as required. This case can preferably be detected in a simple way by a further image processing evaluation of the recorded camera image. The evaluation is carried out in analogy to and in combination with the closure seat check described above, for example as a two-stage procedure. However, since in this case we are dealing with very coarse high seats, only a simple and thus robust height evaluation with only one camera, camera view or e.g. external height sensor is sufficient here, for example. However, this ambiguity detection is not limited to a simple detection, but can meet requirements for the detection of closure high seats larger than 0.5 mm.

In a further preferred embodiment, the apparatus has an ejection device which ejects containers detected as faulty and, in particular, containers detected as incorrectly closed.

In addition, it would also be conceivable to focus the respective optics on the front wall of the container so that any structures arranged on the rear wall are not dissolved in the sharpness (and therefore the rear wall does not provide sharp structures) and it is clear where the actual marking is to be found.

Preferably, as mentioned above, the inspection or control takes place after the containers have been filled and sealed, where water droplets often adhere to both the inner wall and the outer wall in the neck area of the containers. These are more visible in transmitted light. Therefore, the features on the container are preferably formed as distinct and multiple, that is, double or multiple vertical structures present. As described in more detail below, these can be arranged protruding (embossing) or recessed (debossing) both on the outer wall and advantageously on the inner wall.

Preferably, the cross-section of these structures has clear edges for reasons of better recognisability and can, for example, be rectangular, trapezoidal, particularly preferably triangular or sawtooth-shaped, since edges that are close together and, in particular, angled edges enable a particularly strong contrast in a camera image.

The horizontal width of the structures is in the range of 0.25 to 2.5 mm, preferably in the range of 0.5 to 1.5 mm and particularly preferably in the range of 0.75 to 1.25 mm,

The vertical extent of the markings is preferably greater than 1.0 mm, preferably greater than 2.0 mm, preferably greater than 2.5 mm and particularly preferably greater than 3.0 mm. This size has proven to be particularly advantageous as it is above the diameter of typical droplets. Preferably, a linear dimension of these markings is smaller than 3 cm, preferably smaller than 2 cm, preferably smaller than 1 cm and preferably smaller than 8 mm.

Preferably, the evaluation device is suitable and designed to distinguish between such structures or markings and water droplets. For this purpose, for example, a search algorithm can be provided, such as shape matching, which is particularly preferably optimised to recognise the corresponding structure, in particular also in any rotational position.

Alternatively or additionally, the detection of the position of the structures and thus the calculation of the angular position could also take place via a deep neural network, for example CNN. This can be trained, for example, with a large number of annotated (i.e. enriched with angular position information) camera images so that it can determine the position angle from the position and appearance of the marking in the images at runtime.

However, it must be taken into account that the marking is usually located at an essentially fixed height position, i.e. in the image the area in which the markings will be located is ultimately relatively strongly delimited, which also facilitates the detection of the respective structure.

The mark position is predetermined by the bottle production: The marks should be located in an area that does not change due to bottle blowing. It is possible that both the distance of the two lines detected in the image and its position within the image are taken into account to determine the structure, if it is assumed that the imaging device is always essentially aligned with the longitudinal direction of the container.

In a further preferred embodiment, the features on the container and/or the features on the container closure are detectable with the same image detection unit. Preferably, therefore, the image detection unit and/or the image recording device captures both an image of the closure and an image of said area of the container at the same time.

This image detection unit can, as mentioned above, have a camera as well as an illumination.

In a further preferred embodiment, the apparatus has a further lighting device, which is arranged in particular on that side of the container on which the image recording device is also arranged. In this embodiment, (additional) incident light illumination is proposed, which in particular also serves to illuminate the container closure. This is particularly useful if the container closure is made of a non-transparent material, as is usually the case. If only one image recording device is used in this advantageous embodiment, it is preferably arranged at an observation angle obliquely from above, so that both the container closure and the mouth area lying below the container closure can be recorded.

Alternatively, however, it would also be possible for a further image recording device to be provided which also detects the rotational position of the closure using methods known from the state of the art (CETIE). It is possible that these two image recording devices are synchronised with each other. Often, symmetrical multi-part threads, for example three-part threads, are used at the container mouths. If the alignment features are then applied in the same multiplicity, for example three, in a fixed angular relationship to the thread on the container and on the closure, it is not necessary to check the entire mouth circumference, but only the corresponding fraction, for example one third.

If necessary, a little more of the circumference should be imaged in order to be able to clearly recognise the feature at the edge of this frame area as well. In the example, this would be 120°, for example one third of the total circumference+10°, in order to be able to reliably detect the feature or the marking as a whole at the edge position as well. This would allow the containers to be transported past a detection unit at any distance on a transport device, for example on a single-lane conveyor, without the detection device or the apparatus according to the invention obstructing the container flow at the same height as the mouths of the containers.

Preferably, the angular range to be captured can be captured with a single image recording device and a specific optical device. Preferably, then, the image recording device has an optical device that allows an at least partial omnidirectional view to be captured in one piece.

In addition, it would also be possible for the angular range to be composed of several individual views, wherein the partial views advantageously overlap in order to reliably detect the features as a whole in each angular position. Preferably, the multiple views can be imaged via one or more image recording devices or cameras and/or via mirror systems, so that multiple individual views can also be detected with one image recording device, or a separate camera can also be used for each individual view.

In a further preferred embodiment, an image recording device is provided which enables rectification of captured images. This is advantageous because, due to the perspective or oblique image and also the typical circular circumference of the containers and the closure, there is a strongly non-linear relationship between the position of the feature in the camera image and the angular position relative to the container.

Preferably, a viewing direction of the image recording device with a direction perpendicular to the longitudinal direction of the container includes an angle of more than 3°, preferably more than 5°, preferably more than 7° and preferably more than 10° and preferably more than 12°. As mentioned above, a slightly oblique observation of the container is advantageous, in order to be able to eliminate reflections or optical artefacts originating from the rear wall of the container circumference.

However, these artefacts from the back wall are rather secondary because they are blurred when the image is large. Disturbing artefacts come preferentially from the front wall: underneath the support ring, there are circumferential horizontal bulges that act like cylindrical lenses. If one looks horizontally into these bulges, the viewing direction is deflected upwards and downwards. A downward deflection is less critical, but an upward deflection is looking into the lid and thus the marking is not perceptible.

In a preferred embodiment, the lighting device has a width (especially in the circumferential direction of the containers to be inspected) that is selected such that it appears only slightly wider than the closure in a captured image. Thus, the width may be less than a cross-section of the illuminated container. It should be taken into account here that the containers usually have a main body with a cross-section that is larger than the cross-section in the neck or mouth area.

The lamp width is advantageously narrow and slightly wider than the closure in the image. This way the vertical marks darken well and at the complete closure the position can be determined. If the lighting device, such as a lamp, is narrower at the sides, the contrast of the vertical cam flanks or the marks is better. A high narrow illumination device or lamp is particularly preferred, i.e. a lighting device which is long in the longitudinal direction of the container and comparatively short in the direction perpendicular thereto. The narrow design favours the visibility of the markings on the containers. The comparatively large length in the longitudinal direction or the large height is favourable for the suppression of horizontal thickenings.

The present invention is further directed to an inspection device for inspecting filled containers with container closures arranged thereon. This inspection device comprises a transport device which transports the containers along a predetermined transport path. Furthermore, the inspection device has a lighting device which illuminates the containers to be inspected, as well as an image recording device which is suitable and intended for recording spatially resolved images of the containers.

According to the invention, the image recording device is at least also aligned with regions of the containers which are arranged in a longitudinal direction of the containers below the container closures arranged on the containers, and a viewing direction of the image recording device includes an angle of more than 20° with the longitudinal direction of the containers, such that at least one marking attached to the containers can be detected by the image recording device.

Furthermore, the apparatus has an evaluation device which determines a relative rotational position of this container with respect to the container closure arranged on the container from an image taken of the container provided with the marking or from an image taken of this container.

It is thus also proposed with regard to the inspection device that it determines a relative position of the container closure in relation to the container, in order to conclude in this way also on a closure process.

The present invention is further directed to an inspection arrangement for inspecting filled containers with container closures arranged thereon, which comprises an inspection device of the type described above, as well as a container to be inspected, wherein the container closure arranged on the container has at least one first optically perceptible marking, and the container has at least one second optically perceptible marking below the container mouth. As mentioned above, both markings are preferably detectable with the same image recording device. Preferably, said second marking is arranged in a neck region of the container.

The present invention is further directed to a method for inspecting filled containers with container closures screwed thereto, wherein a transport device transports the containers along a predetermined transport path and an inspection device illuminates the containers to be inspected by means of a lighting device and an image recording device records at least one spatially resolved image of the containers.

According to the invention, the image recording device is at least also aligned with regions of the container which are arranged in a longitudinal direction of the container below the container closures arranged on the containers, and a viewing direction of the image recording device closes an angle of more than 20° with the longitudinal direction of the containers in such a way that at least one marking attached to the container is detected by the image recording device. Furthermore, an evaluation device determines from at least one recorded image of the container provided with the marking a relative rotational position of this container with respect to the container closure arranged on the container.

In a preferred method, the evaluation device or another unit outputs at least one signal which is characteristic of whether the container is a correctly closed container or a defectively closed container. Particularly preferably, containers that are detected as faulty are ejected from a production flow. For this purpose, an ejection unit can be arranged downstream of the inspection device, which enables individual containers to be ejected from the production stream.

In a further advantageous method, the relative rotational position of this container with respect to the container closure arranged on the container is determined by means of a neural network, in particular an appropriately trained neural network.

Furthermore, statistical evaluations of the measured rotational positions allow statements to be made about the quality of the closure process. For example, the mean value and standard deviation of the rotational position angle in relation to the individual capper heads can be used in the sense of predictive maintenance to indicate the need for maintenance work on the closure. A more deviating mean value preferably indicates a necessary adjustment of a closure head, while a too large standard deviation or increasing outliers suggests wear and possibly necessary replacement of such a head. The adjustment of the closure head can also be carried out automatically in a closed control loop if the current station-related average value is transmitted to the closure control via suitable interfaces and the closure control adjusts e.g. the closing torque or the target angle via a control algorithm.

Further advantages and embodiments can be seen in the accompanying drawings. In the drawings:

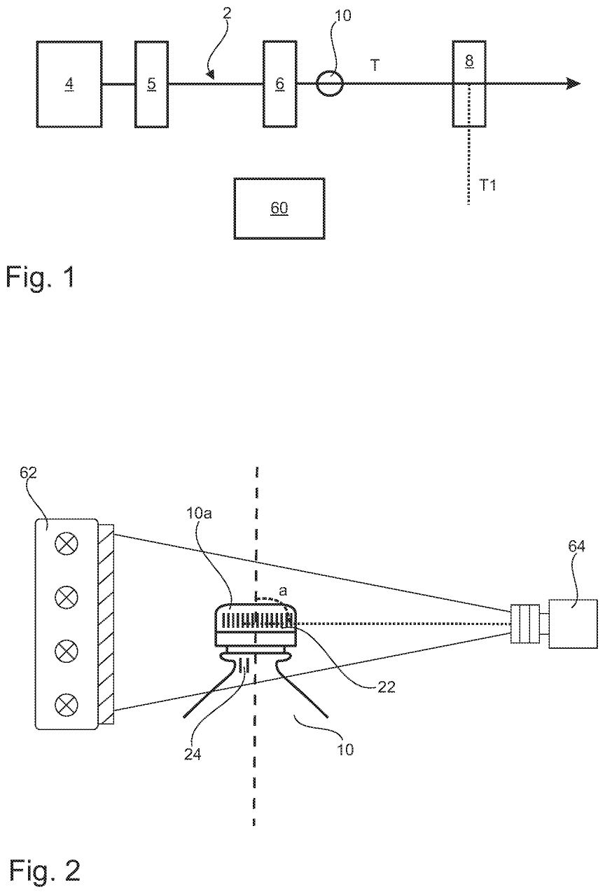

FIG. 1 shows a schematic representation of an apparatus according to the invention;

FIG. 2 shows a schematic representation of an inspection device according to the invention;

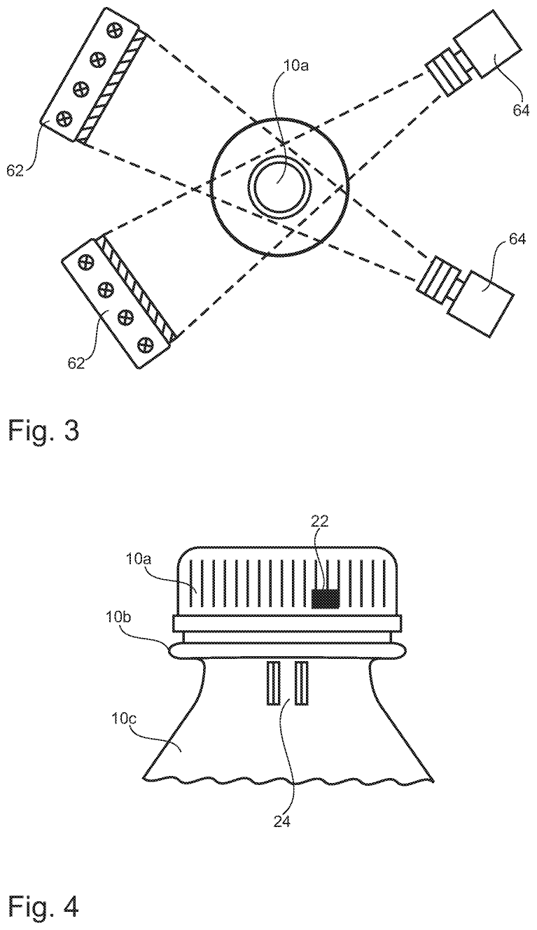

FIG. 3 shows a representation of an inspection device according to the invention in a top view; and

FIG. 4 shows a partial representation of a container to be inspected.

FIG. 1 shows a schematic representation of an apparatus according to the invention. First of all, a filling device 4 is provided which fills containers, for example PET or glass containers, with a liquid. Subsequently, these filled containers are closed by means of a closing device 5, wherein this closing device 5 applies closures to the containers and, in particular, screws them on. The reference sign 2 roughly indicates a transport device which transports the containers 10 between the individual treatment stations.

The reference sign 6 indicates an inspection device which inspects the containers and in particular their closure area in order to determine a rotational position between the closures and the containers. For this purpose, the inspection device 6 has an evaluation device 60 which evaluates recorded camera images.

The reference sign T indicates the transport path of the plastic containers. The reference sign 8 indicates an ejection device which is suitable and intended to eject containers from the transport path T, for example for ejection onto an ejection path T1. Preferably, this ejection device is also controlled by the control and evaluation device 60 and, in particular, ejects those containers that have been detected as defectively closed.

FIG. 2 shows an illustration of the invention. A lighting device 62 is provided which illuminates the container closures. The reference sign 10 indicates the container and the reference sign 10a indicates a closure attached to the container. The reference sign L indicates a longitudinal direction of the container. It can be seen that both a mark 22 is applied to the closure 10a and a mark 24 is applied to the container 10, more precisely in the mouth area of the container. By means of an image recording device 64, the relative position between the mark 22 and the mark 24 (more precisely the relative rotational positions with respect to the longitudinal direction L) can be determined. It is possible that only one camera is sufficient to record these images.

In FIG. 2, the image recording device looks at the container in an exactly horizontal direction or at an angle a of 90° with respect to the longitudinal direction of the container. Advantageously, however, the image recording device looks at the container obliquely from above, preferably at an angle to the longitudinal direction of the container of between 70° and 80°, preferably between 72° and 78° and particularly preferably at about 75°.

FIG. 3 shows a representation in which two image recording devices 64 and also two lighting devices 62 are provided, which however are arranged at an angle to each other with respect to the longitudinal direction of the container, in order to be able to detect the respective markings on the closure 10a and on the container 10, respectively, independently of the respective position of the markings. However, it would also be possible and preferred that an additional lighting device is provided which also illuminates the container closure, wherein this lighting device preferably being arranged on the side of the image recording device 64 (not shown), so as to illuminate the container closure in incident light.

FIG. 4 shows a detailed representation of the container 10 with the closure 10a arranged thereon. The reference sign 10b indicates a support ring of the container and the reference sign 10c indicates the neck or mouth area of the container. It can be seen that the marking 24 is arranged here in the form of two vertical lines directly on the neck area below the support ring.

As mentioned above, containers often have thickenings below this support ring 10b because this is the transition area between the cooled mouth and the heated preform body. These thickenings partially direct the horizontal line of sight into a dark lid, making it more difficult to detect the marking 24. As mentioned above, this can be remedied by viewing from an oblique angle. In this case, it is easier to see under the lid despite the light refractions at the thickenings.

A further improvement can be achieved if the lighting device (shown here only as a dashed line) is narrower at the side, because then the contrast of the vertical cams 24 is improved. A high narrow lamp is optimal, wherein the narrow design serves for the visibility of the cams and the height of the lamp serves for the suppression of the horizontal thickenings.

In this way, darkenings are only narrow and can almost disappear with unsuitable rotation angles. For this reason, appropriately wide, especially oblique flanks should be chosen, i.e. flanks with angles of 30° to 60°, wherein the opposite flank is preferably immediately adjacent (triangular prism).

The applicant reserves the right to claim all features disclosed in the application documents as essential to the invention, provided they are individually or in combination new compared to the prior art. It is further pointed out that the individual figures also describe features which may be advantageous in themselves. The skilled person immediately recognises that a certain feature described in a figure can also be advantageous without adopting further features from this figure. Furthermore, the skilled person recognises that advantages can also result from a combination of several features shown in individual figures or in different figures.

1: An apparatus for treating containers, having a transport device configured to transport the containers along a predetermined transport path, having a filling device configured to fill the containers with a medium, and having a closing device which attaches closures to the filled containers, and having an inspection device which is arranged downstream of the closing device in the transport direction of the containers and which inspects the containers with the container closures arranged thereon, wherein the inspection device having a lighting device which illuminates the containers to be inspected and an image recording device which is suitable and intended for recording spatially resolved images of the containers,
wherein
the image recording device is at least also aligned with regions of the containers which are arranged in a longitudinal direction of the containers below the container closures arranged on the containers, and a viewing direction of the image recording device encloses an angle of more than 20° with the longitudinal direction of the containers, in such a manner in that at least one marking provided on the container can be detected by the image recording device, and in that furthermore an evaluation device is provided which determines, from at least one image recorded of the container provided with the marking, a relative rotational position of this container with respect to the container closure arranged on the container.

2: The apparatus according to claim 1,
wherein
the container to be inspected is arranged between the lighting device and the image recording device.

3: The apparatus according to claim 1, wherein
at least one marking arranged on the closure can also be detected by the image recording device.

4: The apparatus according to claim 1, wherein
the evaluation device is configured to determine the relative rotational position of the container with respect to the container closure arranged on the container from an image taken by the closure provided with the marking.

5: The apparatus according to at claim 1, wherein
the inspection device comprises an evaluation device which is configured to determine a rotational position of the marking arranged on the container from the image recorded by the container.

6: The apparatus according to claim 1, wherein
a viewing direction of the image recording device of a direction perpendicular to the longitudinal direction of the containers encloses an angle of more than 3°.

7: The apparatus according to claim 1, wherein
the lighting device has a width selected such that it appears only slightly wider than the closure in a captured image.

8: An inspection device for inspecting filled containers with container closures arranged thereon, having a transport device configured to transport the containers along a predetermined transport path, wherein the inspection device has a lighting device configured to illuminate the containers to be inspected and an image recording device which is configured to record for recording spatially resolved images of the containers,
wherein
the image recording device is at least also aligned with regions of the containers, which are arranged in a longitudinal direction of the containers below the container closures arranged on the containers, and a viewing direction of the image recording device encloses an angle of more than 200 with the longitudinal direction of the containers, in such a manner in that at least one marking provided on the containers can be detected by the image recording device, and in that furthermore an evaluation device is provided which is configured to determine, from an image recorded of the container provided with the marking, a relative rotational position of this container with respect to the container closure arranged on the container.

9: An Inspection arrangement for inspecting filled containers with container closures arranged thereon, having an inspection device according to claim 8 and at least one container to be inspected, wherein the container closure arranged on the container has a first optically perceptible marking and the container has a second optically perceptible marking below a container mouth.

10: A method for inspecting filled containers with container closures screwed thereto, wherein a transport device transports the containers along a predetermined transport path and an inspection device illuminates the containers to be inspected by a lighting device and an image recording device records spatially resolved images of the containers,
wherein
the image recording device is at least also aligned with regions of the container which are arranged in a longitudinal direction of the container below the container closures arranged on the containers and a viewing direction of the image recording device encloses an angle of more than 20° with the longitudinal direction of the containers, in such a way that at least one marking provided on the containers is detected by
the image recording device, and in that furthermore an evaluation device determines from at least one recorded image of the container provided with the marking a relative rotational position of this container with respect to the container closure arranged on the container.

11: The method for inspecting filled containers with container closures screwed thereto according to claim 10,
wherein
the determination of the relative rotational position of this container with respect to the container closure arranged on the container is carried out by a correspondingly trained neural network.

12: The method according to claim 10, wherein
statements about the quality of the closure process are made by statistical evaluations of the measured rotary positions.

13: The apparatus according to claim 2, wherein
at least one marking arranged on the closure can also be detected by the image recording device.

14: The apparatus according to claim 2, wherein
the evaluation device is configured to determine the relative rotational position of the container with respect to the container closure arranged on the container from an image taken by the closure provided with the marking.

15: The apparatus according to at claim 2, wherein
the inspection device comprises an evaluation device which is configured to determine a rotational position of the marking arranged on the container from the image recorded by the container.

16: The apparatus according to claim 2, wherein a viewing direction of the image recording device of a direction perpendicular to the longitudinal direction of the containers encloses an angle of more than 3°.

17: The apparatus according to claim 2, wherein
the lighting device has a width selected such that it appears only slightly wider than the closure in a captured image.

18: The method according to claim 11, wherein statements about the quality of the closure process are made by statistical evaluations of the measured rotary positions.
